(19) United States
(12) Patent Application Publication
(10) Pub. No.: US 2026/0139823 A1
(43) Pub. Date: May 21, 2026

(54) LAMP ASSEMBLY, AND APPARATUS AND METHOD FOR MANUFACTURING LAMP ASSEMBLY

(71) Applicants: HYUNDAI MOTOR COMPANY, Seoul (KR); KIA CORPORATION, Seoul (KR); SL Corporation, Gyeongsan-si (KR)

(72) Inventors: Joon Bo Shim, Hwaseong-si (KR); Sung Ho Park, Hwaseong-si (KR); Soon Kyu Jung, Daegu (KR); Jin Ho Jo, Gyeongsan-si (KR); Seung Gyu Nam, Gyeongsan-si (KR); Hye Jin Han, Gyeongsan-si (KR); Young Jun Jeon, Daegu (KR)

(73) Assignees: HYUNDAI MOTOR COMPANY, Seoul (KR); KIA CORPORATION, Seoul (KR); SL Corporation, Gyeongsan-si (KR)

(21) Appl. No.: 19/175,891

(22) Filed: Apr. 10, 2025

(30) Foreign Application Priority Data
Nov. 19, 2024 (KR) 10-2024-0164931

(51) Int. Cl. F21V 31/04; F21K 9/66; F21K 9/69; F21S 43/20; F21S 43/50; F21V 3/06; F21V 5/04; F21V 17/10; F21W 104/00; F21Y 115/10

(52) U.S. Cl. CPC F21V 31/04; F21K 9/66; F21K 9/69; F21S 43/28135; F21S 43/50; F21V 3/06; F21V 5/04; F21V 17/101; F21W 2104/00; F21Y 2115/10

(57) ABSTRACT

A method for manufacturing a lamp assembly including a light emitting sheet portion and a lens portion, the method includes mounting the light emitting sheet portion, generating light, on an upper mold, mounting the lens portion, transmitting light generated by the light emitting sheet portion, on a lower mold, coupling the upper mold and the lower mold to each other, and forming a clear layer having light transmissive properties, the clear layer provided between the light emitting sheet portion and the lens portion. The forming the clear layer is performed at room temperature.

### CROSS-REFERENCE TO RELATED APPLICATION(S)

This application claims the benefit of priority to Korean Patent Application No. 10-2024-0164931 filed on Nov. 19, 2024, in the Korean Intellectual Property Office, the disclosure of which is incorporated herein by reference in its entirety.

### TECHNICAL FIELD

The present disclosure relates to a lamp assembly and a method for manufacturing the same.

### BACKGROUND

An EL device, such as an inorganic EL device or an organic EL device, may perform self-emission to obtain a high-brightness surface light source. Accordingly, EL devices have been put to use as thin and light displays or surface light emitting devices.

For example, EL devices may have a structure with multiple layers. For example, the layers may include a transparent electrode layer having light transmissive properties, and the transparent electrode layer may include indium tin oxide (ITO). The layers may also include a thin film layer having a light emitting layer and a metal electrode layer having light reflective properties, including Al. Further, for example, the layers may be sequentially stacked on a transparent substrate including glass or the like to form an EL element.

Light emitted from the light emitting layer may directly pass through the transparent electrode layer, or light may be reflected from the metal electrode layer, and may then pass through the transparent electrode layer. Thereafter, light may pass through the transparent substrate, and may be emitted from a boundary surface between the transparent substrate and outside air, functioning as a light emitting surface.

Such EL devices may not be visually transparent, such that a degree of design freedom and light efficiency may be lowered.

The features described above as background technology are intended to enhance understanding of the background of the present disclosure, and should not be construed as acknowledging that they correspond to the known related art.

### SUMMARY

An aspect of the present disclosure provides a lamp assembly in which a transparent light emitting sheet portion is provided.

Another aspect of the present disclosure provides an apparatus and method for manufacturing a lamp assembly, the apparatus and method are capable of providing a transparent light emitting sheet portion without a heat-resistant structure or device.

The aspects of the present disclosure are not limited to those set forth herein, and other aspects set forth herein may be understood by those skilled in the art from the description herein.

According to an aspect of the present disclosure, there is provided a method for manufacturing a lamp assembly including a light emitting sheet portion and a lens portion. The method may include mounting the light emitting sheet portion, generating light, on an upper mold, mounting the lens portion, transmitting light generated by the light emitting sheet portion, on a lower mold, coupling the upper mold and the lower mold to each other, and forming a clear layer having light transmissive properties. The clear layer may be provided between the light emitting sheet portion and the lens portion. The forming the clear layer may be performed at room temperature.

Forming the clear layer may include injecting an optical transparent resin and curing the optical transparent resin.

The optical transparent resin may be formed of an ultraviolet (UV)-curable resin.

In curing the optical transparent resin, the optical transparent resin may be irradiated with UV rays.

In mounting the light emitting sheet portion on the upper mold, an auxiliary fixing portion, temporarily adhering the light emitting sheet portion and the upper mold to each other, may be disposed between the light emitting sheet portion and the upper mold.

In mounting the light emitting sheet portion on the upper mold, a (e.g., one) surface of the light emitting sheet portion may be provided in a state in which an image is printed on at least a portion thereof, and the light emitting sheet portion may be mounted on the upper mold such that the a (e.g., one) surface is in contact with the upper mold.

According to another aspect of the present disclosure, there is provided an apparatus for manufacturing a lamp assembly including a light emitting sheet portion and a lens portion. The apparatus may include an upper mold on which the light emitting sheet portion, generating light, is mounted, a lower mold on which the lens portion, transmitting light generated by the light emitting sheet portion, is mounted, and an UV lamp irradiating the upper mold and the lower mold with UV rays. The upper mold and the lower mold may allow light to pass therethrough.

When the upper mold and the lower mold are pressurized, the light emitting sheet portion and the lens portion may come into contact to form a filling space. The upper mold may include an injection port passing through the upper mold, and an optical transparent resin is injected through the injection port into the filling space.

The injection port may be provided to protrude toward a contact surface of the upper mold that is in contact with the light emitting sheet portion.

The injection port may be provided to protrude toward a contact surface of the upper mold that is in contact with the light emitting sheet portion.

The lens portion may have a shape corresponding to a shape of the light emitting sheet portion, and may include a rib portion (e.g., continuously) protruding toward the upper mold.

A portion of the rib portion may have a shape corresponding to a shape of the injection port, and may further include an injection auxiliary portion protruding toward the upper mold. The injection auxiliary portion may surround the injection port.

According to another aspect of the present disclosure, there is provided a lamp assembly including a transparent layer having light transmissive properties, an electrode layer stacked on the transparent layer with the electrode layer having a light emitting structure generating light, a lens portion spaced apart from the electrode layer by a predetermined interval with the lens portion provided to surround the electrode layer, and a clear layer provided between the electrode layer and the lens portion using an optical transparent resin. An opposite surface on which the electrode layer is stacked, among both surfaces of the transparent layer, may be coupled to an image layer. The image layer may include an image having a preset color printed thereon.

The lens portion may include a first lens portion provided to be transparent, and a second lens portion connected to the first lens portion. The second lens portion may have a color.

The second lens portion and the image layer may have the same color.

The optical transparent resin may be provided as one of an optical clear resin (OCR) or an optical clear adhesive (OCA).

In a lamp assembly according to an example embodiment of the present disclosure, light may be emitted from a transparent sheet to implement a lamp function, thereby improving light emission efficiency and securing a degree of design freedom.

In addition, in the lamp assembly according to an example embodiment of the present disclosure, an air layer may be removed, thereby preventing the generation of moisture in a lamp structure.

The effects of the present disclosure are not limited to those set forth herein, and other effects not set forth herein may be recognized by those skilled in the art from the description below.

### BRIEF DESCRIPTION OF DRAWINGS

The above and other aspects, features, and advantages of the present disclosure will be understood from the following detailed description, taken in conjunction with the accompanying drawings.

FIG. 1 is a perspective view of a lamp assembly according to an example embodiment of the present disclosure.

FIG. 2 is a diagram illustrating a transparent light emitting sheet according to an example embodiment of the present disclosure.

FIG. 3 is a diagram illustrating an electrode pattern of an electrode layer in a transparent light emitting sheet according to the present disclosure.

FIG. 4 is a cross-sectional view taken along line I-I of FIG. 1.

FIG. 5 is an enlarged view of portion “A” of FIG. 4.

FIG. 6 is a block diagram illustrating a process of manufacturing a lamp assembly according to an example embodiment of the present disclosure.

FIG. 7 is a diagram illustrating a process of manufacturing a lamp assembly according to an example embodiment of the present disclosure.

FIG. 8 is a diagram illustrating a process of manufacturing a lamp assembly according to an example embodiment of the present disclosure.

FIG. 9 is a diagram illustrating a manufacturing process of S1000 of FIG. 6 according to an example embodiment of the present disclosure.

FIG. 10 is a diagram illustrating a manufacturing process of S1100 of FIG. 6 according to an example embodiment of the present disclosure.

FIG. 11 is a diagram illustrating a manufacturing process of S1200 of FIG. 6 according to an example embodiment of the present disclosure.

FIG. 12 is a diagram illustrating a manufacturing process of S1300 of FIG. 6 according to an example embodiment of the present disclosure.

FIG. 13 is a diagram illustrating a manufacturing process of S1300 of FIG. 6 according to an example embodiment of the present disclosure.

FIGS. 14A and 14B are diagrams illustrating a manufacturing process of S1300 of FIG. 6 according to an example embodiment of the present disclosure.

FIG. 15 is a diagram illustrating a manufacturing process of S1400 of FIG. 6 according to an example embodiment of the present disclosure.

FIG. 16 is a schematic diagram illustrating a process of assembling a light emitting sheet portion, a light emitting assembly, and a lamp assembly according to an example embodiment of the present disclosure.

FIGS. 17A and 17B are diagrams illustrating a use state of a lamp assembly according to an example embodiment of the present disclosure.

FIGS. 18A and 18B are diagrams illustrating a use state of a lamp assembly according to an example embodiment of the present disclosure.

FIG. 19 is a diagram illustrating reflected light of a lamp assembly according to the related art.

FIG. 20 is a diagram illustrating reflected light of a lamp assembly according to an example embodiment of the present disclosure.

### DETAILED DESCRIPTION

Various modifications may be made to the example embodiments. Here, the example embodiments should not be construed as being limited to the present disclosure and should be understood to include changes, equivalents, and replacements within the idea and the technical scope of the disclosure.

The terms such as first, second, A, B, (a), (b), and the like may be used herein to describe components. Each of these terminologies is not used to provide an essence, order, or sequence of a corresponding component but is used to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “portion,” “part,” and the like may be used to describe various components, but the components should not be limited by the terms. The above-described terms may refer to a term indicating a physically/visually distinct component and also a function or component of a corresponding portion even when not (e.g., clearly) divided or partitioned.

The terminology used herein is for the purpose of describing particular example embodiments and is not to be limited to the example embodiments. As used herein, the singular forms “a,” “an,” and “the” are intended to include the plural forms as well, unless the context (e.g., clearly) indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

Hereinafter, example embodiments of the present disclosure will be described in more detail with reference to the drawings.

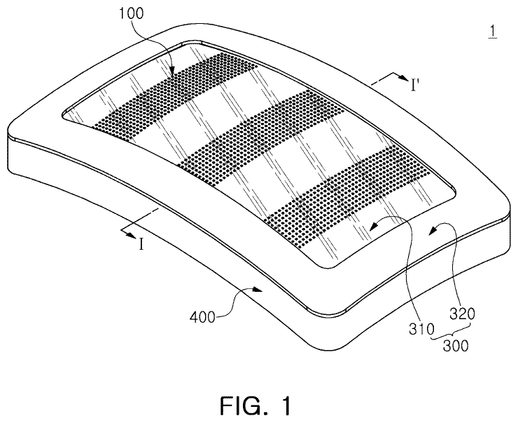

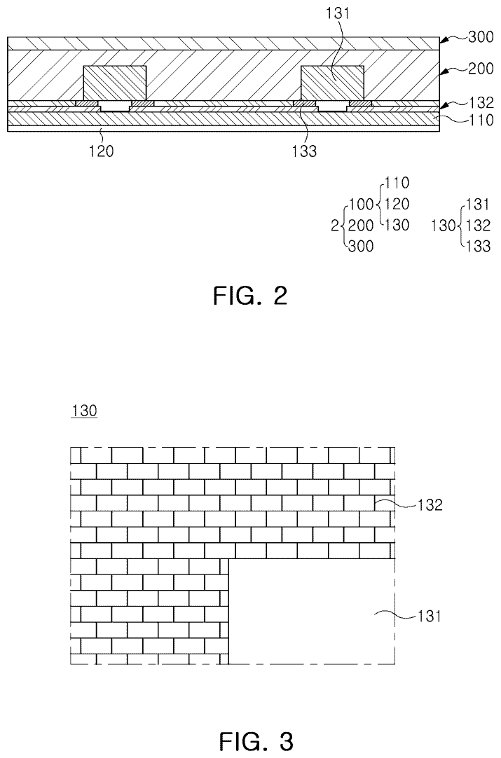

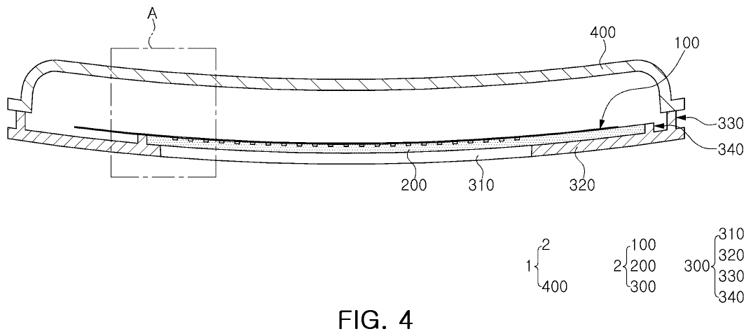

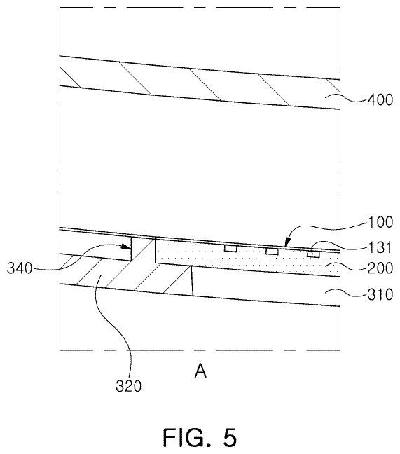

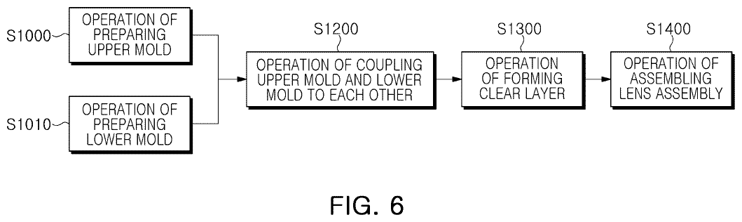

FIG. 1 is a perspective view of a lamp assembly 1 according to an example embodiment of the present disclosure. FIG. 2 is a diagram illustrating a transparent light emitting sheet according to an example embodiment of the present disclosure. FIG. 3 is a diagram illustrating an electrode pattern of an electrode layer in a transparent light emitting sheet according to the present disclosure. FIG. 4 is a cross-sectional view taken along line I-I of FIG. 1. FIG. 5 is an enlarged view of portion “A” of FIG. 4.

Referring to FIGS. 1 to 5, a lamp assembly 1 according to an example embodiment of the present disclosure may include a light emitting assembly 2 including a light emitting sheet portion 100, a clear layer 200, a lens portion 300, and a housing portion 400 coupled to the light emitting assembly 2.

The housing portion 400 may be coupled to the lens portion 300 with the light emitting sheet portion 100 interposed therebetween.

The lens portion 300 may be provided such that at least a portion of the lens portion 300 transmits light.

The lens portion 300 may include at least two lens portions 300 having different degrees of light transmission. For example, the lens portion 300 may include a first lens portion 310 transmitting a (e.g., larger) amount of light, and a second lens portion 320 transmitting an amount of light less than the amount of light transmitted by the first lens portion 310.

The first lens portion 310 may be transparent to transmit light irradiated from the light emitting sheet portion 100 to be described below, and the second lens portion 320 may be connected to the first lens portion 310 to support the first lens portion 310. Further, the second lens portion 320 may have a color different from a color of the first lens portion 310.

For example, the first lens portion 310 may be transparent to show a color of the light emitting sheet portion 100 provided in the first lens portion 310, and the second lens portion 320 may have a color similar to that of a vehicle body to provide a (e.g., substantially) continuous aesthetic with the vehicle body.

The light emitting sheet portion 100 may be provided between the lens portion 300 and the housing portion 400, may be in contact with the lens portion 300, and may generate light transmitted through the lens portion 300. At least a portion of the lens portion 300 may transmit light generated by the light emitting sheet portion 100.

The light emitting sheet portion 100 may include a transparent layer 110 having light transmissive properties, an electrode layer 130 stacked on the transparent layer 110, and a clear layer 200. The electrode layer 130 may have conductivity. The electrode layer 130 may have a light emitting structure 131 provided thereon or therein. The clear layer 200 may be filled between the lens portion 300 and the electrode layer 130 to cover the electrode layer 130, and the clear layer 200 may have light transmissive properties.

Here, at least a portion (e.g., of a region) of the lens portion 300 in contact with the light emitting sheet portion 100 may transmit light. For example, a portion (e.g., of a region) of the lens portion 300 in contact with the light emitting sheet portion 100 may include the first lens portion 310.

The transparent layer 110 may be provided on a lower end of the light emitting sheet portion 100, and may be formed of an acrylic blended composition that is photocurable or thermos-curable. The acrylic blending composition may have a (e.g., desired) surface hardness.

For example, the transparent layer 110 may be formed of polyethylene terephthalate (PET). Here, when formed of PET, the transparent layer 110 may easily secure transparency, may be easily produced, and may have a low coefficient of thermal expansion to prevent cracks from occurring in the electrode layer 130 due to heat.

In addition, the transparent layer 110 may be formed of polyethylene naphthalate (PEN) or poly carbonate (PC) in addition to PET. The transparent layer 110 may be (e.g., preferably) formed of a PET material, as a PEN material may have an associated high-price when compared to its (e.g., high) heat resistance and a PC material may be used (e.g., only) in a limited temperature range.

The electrode layer 130 may be stacked on the transparent layer 110, which may have conductivity, and may include a light emitting structure 131.

The electrode layer 130 may have conductivity, such that power may be supplied to the light emitting structure 131, fixed to the electrode layer 130, and light may pass through the electrode layer 130.

The electrode layer 130 may be deposited, such that an electrode 132 formed of a copper material may form a pattern. The electrode layer 130 may be formed of a copper material and may have a width of 0.25 μm. The electrode layer 130 may be formed of various materials such as gold, silver, titanium, and the like; however, the electrode layer 130 may be (e.g., preferably) formed of a copper material to secure electrical energy efficiency and reduce unit cost.

Referring to FIG. 2, the electrode 132 of the electrode layer 130 may be formed to have a mesh pattern. For example, the electrodes 132, formed of a copper material, of the electrode layer 130, may be formed to intersect each other in a mesh shape.

The electrode layer 130 may be provided as a mesh-type electrode layer 130, such that the electrode layer 130 may implement uniform transparency over the (e.g., entire) exterior thereof. The electrode layer 130 may have improved heat resistance performance by (e.g., evenly) distributing heat generated in the electrode 132 to the (e.g., entire) surface thereof providing uniform power transmission over the (e.g., entire) surface thereof.

In addition, even when a portion of the electrode 132 is damaged or deformed due to long-term use, the mesh-type electrode layer 130 may maintain a function of the electrode layer 130 through a remaining portion of the electrode 132.

Here, the electrode 132 may have a plurality of through-holes, and may be deposited on the transparent layer 110 in a lattice shape. The shape of the electrode 132 is not limited to a mesh shape and may have various shapes.

The electrode layer 130 may be treated with black oxide through a photo process and may include a land portion in which the light emitting structure 131 is provided.

In addition, the light emitting structure 131 may be formed of a light emitting diode (LED), and may be soldered in a state of being mounted on the land portion, and may be connected to the electrode 132.

The electrode layer 130 of the light emitting sheet portion 100 may be provided through an example process described below.

The electrode layer 130 may be provided on an upper end of the transparent layer 110.

First, in order to prepare the electrode layer 130, copper may be deposited on the upper end of the transparent layer 110.

Here, a copper deposition process may be performed on the transparent layer 110 using a deposition method according to physical vapor deposition (PVD).

A photosensitive film may be coated through a photoresist (PR) process, and a mask for forming a land portion may be mounted and then exposure may be performed thereon.

The exposed PR may be developed by a developer, and may be subject to an etching process through an etchant. After a PR layer is removed, black oxide and an oxidizing agent may be added to have a blocking film.

The electrode layer 130 may have transparent conductivity, and a soldering portion 133 in which the light emitting structure 131 is provided may be formed.

When the generation of the transparent layer 110 and the electrode layer 130 is completed, a mask may be matched to the electrode layer 130 and then a soldering process may be performed.

For example, after molten solder is generated in the soldering portion 133 of the electrode layer 130, the light emitting structure 131 may be mounted and fixed via solder.

The light emitting structure 131 may be formed of an LED, and may also be applied to an LED having a small size to increase transparency.

Here, a plurality of light emitting structures 131 may be mounted on and fixed to the electrode layer 130.

Here, the electrode layer 130 may function as an electronic circuit.

Referring to FIG. 2, the lamp assembly 1 according to an example embodiment of the present disclosure may further include a clear layer 200.

The clear layer 200 may be provided between the lens portion 300 and the electrode layer 130. The clear layer 200 may be provided by filling a material between the lens portion 300 and the electrode layer 130 to cover the electrode layer 130.

The clear layer 200 may be formed of an optical transparent resin having light transmissive properties.

For example, the clear layer 200 may be formed of an optical clear resin (OCR) or an optical clear adhesive (OCA), and may be filled between the electrode layer 130 and the lens portion 300 to prevent damage to the light emitting structure 131 due to external influences and to improve light efficiency.

The clear layer 200, formed of the OCR or the OCA, may reduce reflection of a portion of light passing through a boundary surface of the lens portion 300, thereby improving light transmissive properties.

Accordingly, the transparency of the light emitting sheet portion 100 may be secure, and the clarity of light emitted from the light emitting structure 131 may be improved.

In addition, the light emitting sheet portion 100 according to an example embodiment of the present disclosure may further include an image layer 120 provided on a lower end of the transparent layer 110.

The image layer 120 may be printed on the lower end of the transparent layer 110.

Here, the image layer 120 may be printed on a PET film using at least one printing method, such as screen printing, digital printing, pad printing, heat transfer printing, laser marking, and UV printing.

Here, the clear layer 200, the lens portion 300, and the transparent layer 110 may have a refractive index of about 1.4 to 1.5, but the present disclosure is not limited thereto, and the refractive indices of the lens portion 300, the transparent layer 110, and the clear layer 200 may be approximately similar to each other.

When an air layer is present between the lens portion 300 and the transparent layer 110, a color implemented in the image layer may be distorted due to reflection of external light.

However, as the lamp assembly 1 according to an example embodiment of the present disclosure is filled with an optical transparent resin having a refractive index similar to those of the lens portion 300 and the transparent layer 110, the color implemented in the image layer 120 may be maintained.

Referring to FIGS. 4 and 5, the lamp assembly 1 according to an example embodiment of the present disclosure may further include a housing portion 400 coupled to the lens portion 300 such that a transparent sheet portion is provided therebetween.

The housing portion 400 may support the lens portion 300 coupled to the transparent sheet portion, and may be provided to connect the lamp assembly 1 to a vehicle body (not illustrated).

Here, the housing portion 400 and the lens portion 300 may be connected to each other using thermal fusion. Various methods may be applied to connect the housing portion 400 and the lens portion 300 to each other.

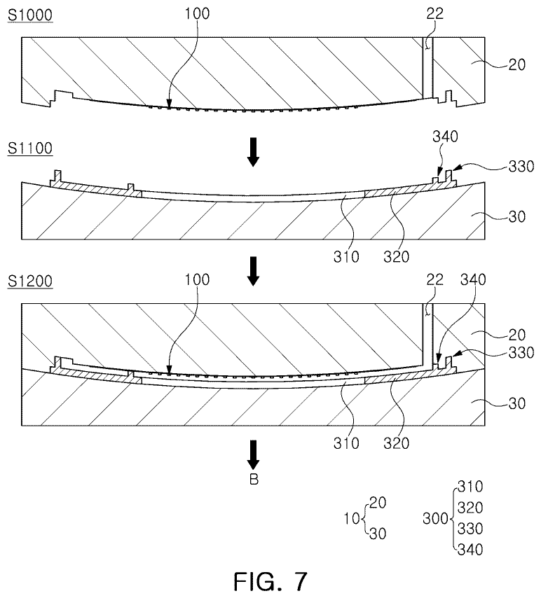

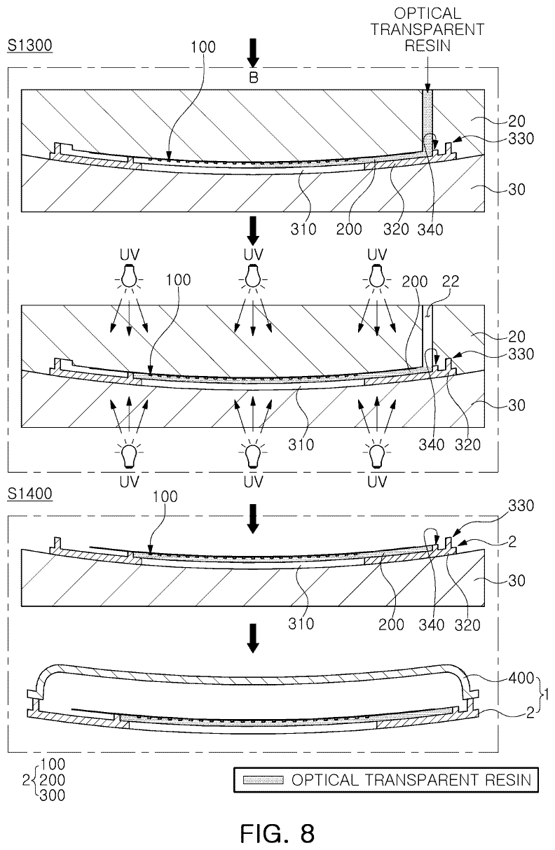

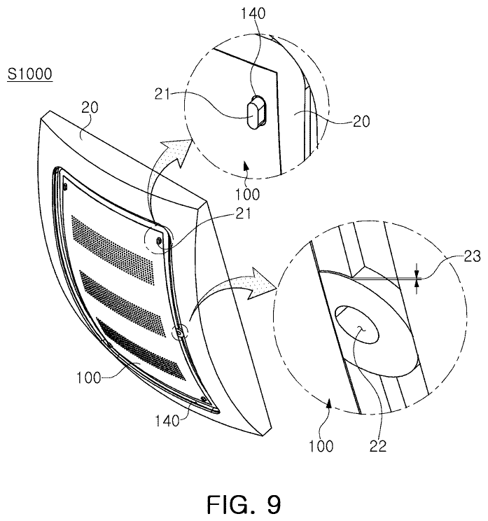

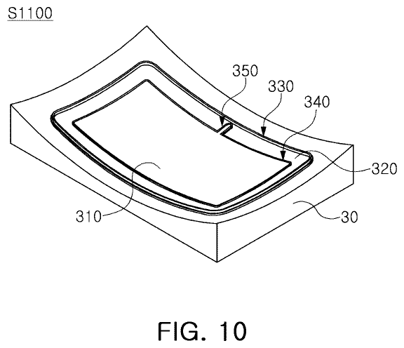

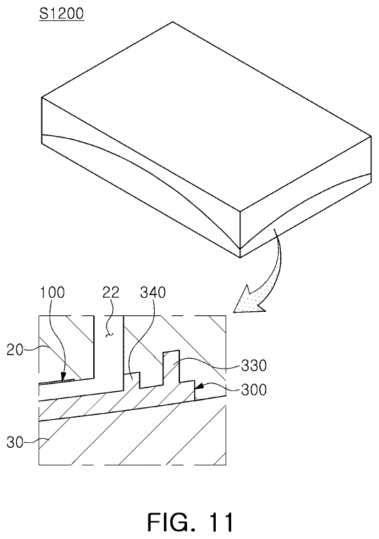

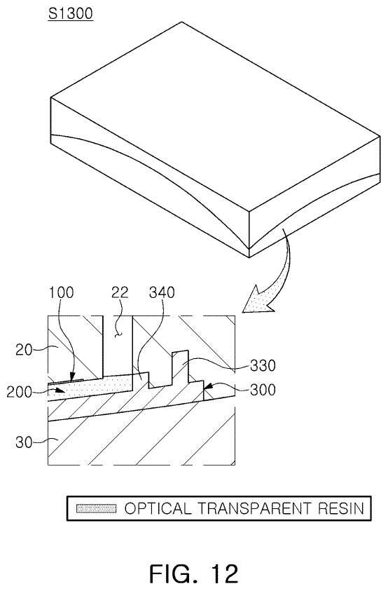

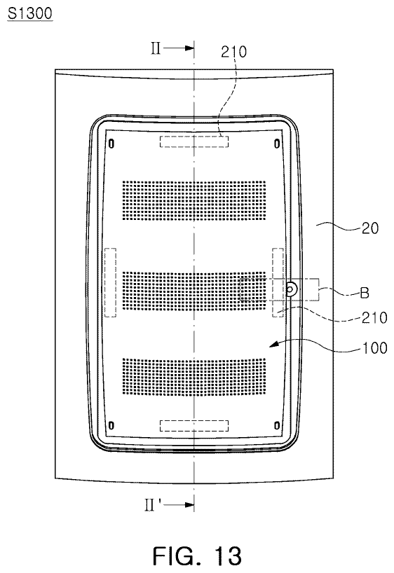

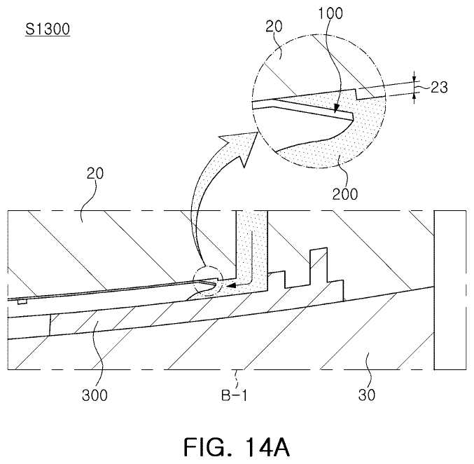

FIG. 6 is a block diagram illustrating a process of manufacturing a lamp assembly 1 according to an example embodiment of the present disclosure. FIGS. 7 and 8 are diagrams illustrating a process of manufacturing a lamp assembly 1 according to an example embodiment of the present disclosure. FIG. 9 is a diagram illustrating a manufacturing process of S1000 of FIG. 6 according to an example embodiment of the present disclosure. FIG. 10 is a diagram illustrating a manufacturing process of S1100 of FIG. 6 according to an example embodiment of the present disclosure. FIG. 11 is a diagram illustrating a manufacturing process of S1200 of FIG. 6 according to an example embodiment of the present disclosure. FIG. 12 is a diagram illustrating a manufacturing process of S1300 of FIG. 6 according to an example embodiment of the present disclosure. FIG. 13 is a diagram illustrating a manufacturing process of S1300 of FIG. 6 according to an example embodiment of the present disclosure.

Referring to FIGS. 6 to 13, a process of manufacturing the lamp assembly 1 according to an example embodiment of the present disclosure is provided.

Referring to FIGS. 6 and 7, the process of manufacturing the lamp assembly 1 according to an example embodiment of the present disclosure may include an operation of mounting the lamp assembly 1 on a mold 10 of a manufacturing apparatus. For example, the process may include an operation S1000 of mounting a light emitting sheet portion 100 on an upper mold 20, and an operation S1100 of mounting a lens portion 300 on a lower mold 30.

Here, the operation of mounting the light emitting sheet portion 100 on the upper mold 20 and the operation of mounting the lens portion 300 on the lower mold 30 may be performed in a different order. That is, the light emitting sheet portion 100 may be mounted first on the upper mold 20, or the lens portion 300 may be mounted first on the lower mold 30.

When the operation of mounting the lamp assembly 1 on the mold 10 of the manufacturing apparatus is completed, an operation S1200 of coupling the upper mold 20 and the lower mold 30 to each other may be performed, and an operation S1300 of forming a clear layer 200 in a state in which the upper mold 20 and the lower mold 30 are coupled to each other may be performed.

Thereafter, a combination of the lens portion 300 and the light emitting sheet portion 100, extracted from the mold 10, may be coupled to the housing portion 400 (S1400).

S1000 to S1200 will be described in more detail with reference to FIGS. 8 to 10, together with FIGS. 6 and 7.

Referring to FIG. 9, the upper mold 20 may include a first alignment portion 21 provided to protrude downwardly. The light emitting sheet portion 100 may include a second alignment portion 140 provided in a position corresponding to that of the first alignment portion 21, and the second alignment portion 140 may be recessed or penetrated, such that the first alignment portion 21 may be inserted into the second alignment portion 140.

Here, the first alignment portion 21 of the upper mold 20 may be mounted on and inserted into the second alignment portion 140 of the light emitting sheet portion 100, such that the light emitting sheet portion 100 may be stably bound to the upper mold 20, and the light emitting sheet portion 100 may be aligned with the upper mold 20 in a state preset by a user.

Here, the first alignment portion 21 provided in the upper mold 20 may be recessed, and the second alignment portion 140 provided in the light emitting sheet portion 100 may protrude. Thus, the second alignment portion 140 may be inserted into the first alignment portion 21, such that the light emitting sheet portion 100 may be supported by the upper mold 20.

The upper mold 20 may include an injection port 22, a point not interfering with the light emitting sheet portion 100 supported through the first alignment portion 21 and the second alignment portion 140. The injection port 22 may have an optical transparent resin injected therethrough.

The injection port 22 may be a passage passing through the upper mold 20 from the outside of the upper mold 20 to a surface on which the upper mold 20 and the light emitting sheet portion 100 are in contact with each other. An optical transparent resin may be filled into a filling space to be described below through the injection port 22.

A discharge side of the injection port 22 provided in the upper mold 20 may be (e.g., preferably) provided to be adjacent to the light emitting sheet portion 100, but the present disclosure is not limited thereto.

Referring to FIGS. 10 and 11, the lens portion 300 may be mounted on the lower mold 30.

The lens portion 300 may include a connection portion 330 bent and protruding toward the upper mold 20 or the light emitting sheet portion 100 along an outer circumferential surface of the lens portion 300. The lens portion 300 also may include a rib portion 340 inwardly spaced apart from the connection portion 330, wherein the rib portion 340 may continuously protrude from the connection portion 330.

When the upper mold 20 and the lower mold 30 are coupled to each other, the overall rib portion 340 may be provided to be in contact with the light emitting sheet portion 100.

The rib portion 340 may include an injection auxiliary portion 350 in a position corresponding to that of the injection port 22 of the upper mold 20. The rib portion 340 may include an injection auxiliary portion 350 protruding outwardly to correspond to the injection port 22 of the upper mold 20, and the injection port 22 of the upper mold 20 may be surrounded by the injection auxiliary portion 350.

Here, the injection port 22 may be provided on the outside of the upper mold 20 to avoid interference with the light emitting sheet portion 100, such that the rib portion 340 may come into contact with both the light emitting sheet portion 100 and the injection port 22 of the upper mold 20.

As a result, a difference may occur in a distance between the light emitting sheet portion 100, in contact with the rib portion 340, and the injection port 22 of the upper mold 20, and an optical transparent resin may leak from a connection portion between the light emitting sheet portion 100 and the injection port 22.

Accordingly, a lower portion of the injection port 22 of the upper mold 20 may have a step portion 23 corresponding to a thickness of the transparent sheet portion in consideration of a thickness of the light emitting sheet portion 100.

Alternatively, the injection auxiliary portion 350 provided in the rib portion 340 may have a step portion 23 corresponding to a thickness of the light emitting sheet portion 100 in consideration of a thickness of the light emitting sheet portion 100.

The step portion 23 corresponding to the light emitting sheet portion 100 may be formed in the injection port 22 or the injection auxiliary portion 350. Thus, most of the rib portion 340 may be in contact with the transparent sheet portion to provide a filling space, and the injection auxiliary portion 350 and the injection port 22 having a step portion 23 may be in contact with each other to prevent the optical transparent resin from deviating the filling space.

In addition, the optical transparent resin injected through the injection port 22 may be induced to the filling space using the injection auxiliary portion 350, thereby increasing a contact area between the rib portion 340 and the light emitting sheet portion 100, and improving contact force between the rib portion 340 and the light emitting sheet portion 100 to prevent leakage of the optical transparent resin.

Referring to FIGS. 8 and 12, the clear layer 200 may be prepared by curing the optical transparent resin filled in the filling space using an ultraviolet (UV) lamp.

According to the related art, a method for directly injecting the clear layer 200 using high-temperature plastic may be used. For example, a method for directly injecting transparent plastic such as polycarbonate (PC) or polymethyl methacrylate (PMMA) into a filling space may be applied to remove an air layer between the light emitting sheet portion 100 and the lens portion 300.

In the method for directly injecting transparent plastic, the light emitting sheet portion 100 (for example, the light emitting structure 131, the electronic circuit, the transparent layer 110, or the like) may be damaged due to flowing high-temperature plastic (e.g., 200 degrees or higher).

In order to prevent damage caused by the high-temperature plastic, the light emitting structure 131 having heat resistance or a high-heat-resistant film may be applied, or a thick circuit may be applied. However, production cost may be increased, or a transparent light emitting sheet portion 100 may not be manufactured.

Accordingly, the lamp assembly 1 according to an example embodiment of the present disclosure may fill a filling space between the light emitting sheet portion 100 and the lens portion 300 with a UV-curable optical transparent resin, and the mold 10, supporting the light emitting sheet portion 100 and the lens portion 300, may be formed of a material through which UV rays are passable, such that UV rays may be irradiated from the outside of the mold 10 to cure the optical transparent resin, thereby preparing the clear layer 200.

Thus, the clear layer 200 may be prepared by applying a transparent circuit and a transparent film formed of a material other than a material having high heat resistance, thereby externally exposing the image layer 120 on a lower end of the transparent layer 110 while preventing an increase in production cost.

Here, the upper mold 20 and the lower mold 30 may be formed of a transparent material (for example, glass or the like) through which UV rays are passable. In a state in which the upper mold 20 and the lower mold 30 are coupled to each other, the optical transparent resin injected into the filling space may be irradiated with UV rays, using a UV lamp, and cured.

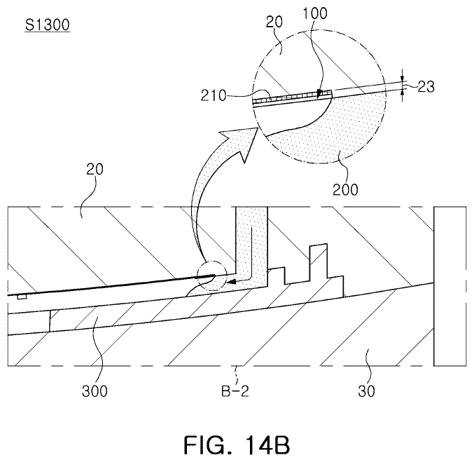

Referring to FIGS. 13 and 14B, the light emitting sheet portion 100 and the upper mold 20 may be temporarily coupled to each other through an auxiliary fixing portion 210.

Here, the auxiliary fixing portion 210 may be a temporary adhesive tape capable of temporarily adhering the light emitting sheet portion 100 to the upper mold 20.

Referring to FIG. 14A, when the optical transparent resin is injected in the absence of the auxiliary fixing portion 210 between the light emitting sheet portion 100 and the upper mold 20, the optical transparent resin having fluidity may be introduced into a space between the light emitting sheet portion 100 and the upper mold 20.

Here, when the optical transparent resin is introduced into the space between the light emitting sheet portion 100 and the upper mold 20, the light emitting sheet portion 100 and the lens portion 300 may have a non-uniform gap, and wrinkles may occur in the light emitting sheet portion 100.

Referring to FIG. 14B, the light emitting sheet portion 100 and the upper mold 20 may be bonded to each other through the auxiliary fixing portion, temporarily fixing the light emitting sheet portion 100 and the upper mold 20 to each other, thereby preventing the optical transparent resin from being introduced into the space between the light emitting sheet portion 100 and the upper mold 20, and allowing the optical transparent resin to be filled (e.g., only) in the filling space to improve product quality.

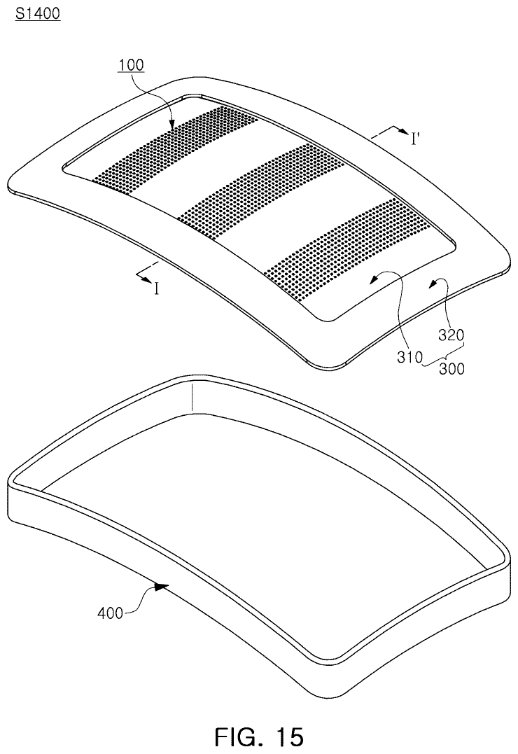

Referring to FIG. 15, the housing portion 400 and the light emitting assembly 2 may be coupled to each other to manufacture the lamp assembly 1.

Here, the housing portion 400 may be coupled to the light emitting assembly 2 through the connection portion 330 provided in the lens portion 300 of the light emitting assembly 2, the connection portion 330 bent and protruding along the outer circumferential surface of the lens portion 300.

Here, the lens portion 300 of the light emitting assembly 2 may include the connection portion 330, and the light emitting assembly 2 may be connected to the housing portion 400 through the connection portion 330 of the lens portion 300 using thermal fusion. However, the present disclosure is not limited thereto, and the housing portion 400 and the lens portion 300 may be connected to each other through bolting.

Various methods may be applied to connect the housing portion 400 and the light emitting assembly 2 to each other.

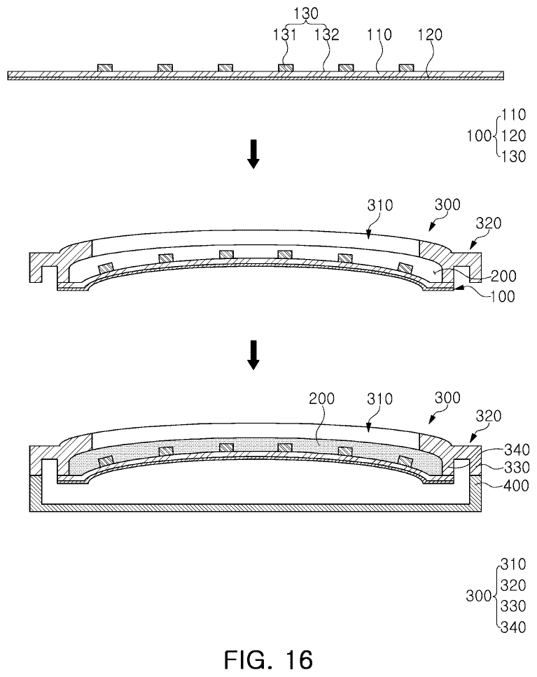

FIG. 16 is a schematic diagram illustrating a process of assembling a light emitting sheet portion 100, a light emitting assembly 2, and a lamp assembly 1 according to an example embodiment of the present disclosure.

Referring to FIG. 16, a process of assembling the light emitting assembly 2 and the lamp assembly 1 according to an example embodiment of the present disclosure is illustrated.

First, the light emitting sheet portion 100 may be prepared.

The light emitting sheet portion 100 may include a light emitting structure 131 and an electrode layer 130 to generate light, and may further include an image layer 120 having an image printed on an (e.g., opposite) surface, in contact with the electrode layer 130, of the transparent layer 110 provided on a lower portion of the light emitting structure 131.

The light emitting sheet portion 100 may be coupled to the lens portion 300 with the clear layer 200 interposed therebetween.

Here, the clear layer 200 may be formed using an UV-curable optical transparent resin.

As the clear layer 200 is provided between the light emitting sheet portion 100 and the lens portion 300, the air layer may be removed between the lens portion 300 and the transparent sheet portion.

When the air layer is formed between the lens portion 300 and the transparent sheet portion, the lens portion 300, the transparent sheet portion, and the air layer may be formed to have different refractive indices. Due to the different refractive indices, even when the image layer, on a lower end of the transparent sheet portion, and the lens portion 300 are manufactured to have the same color, a slight difference may visually occur, such that a difference in color may be recognized.

As a result, the lens portion 300, the transparent sheet portion, and the clear layer 200 may be formed to have similar refractive indices, such that light of the image layer 120, on the lower end of the transparent sheet portion, may be recognized without distortion, and moisture may be fundamentally blocked from occurring between the lens portion 300 and the transparent sheet portion.

In addition, as the light emitting sheet portion 100 and the lens portion 300 are coupled to each other through the clear layer 200, the light emitting sheet portion 100 may be changed according to a shape of the lens portion 300 varying depending on a vehicle.

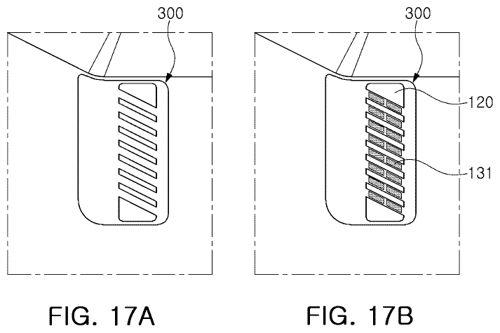

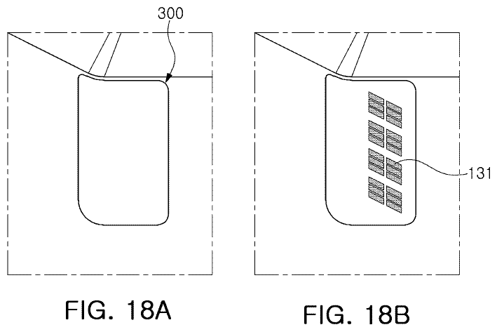

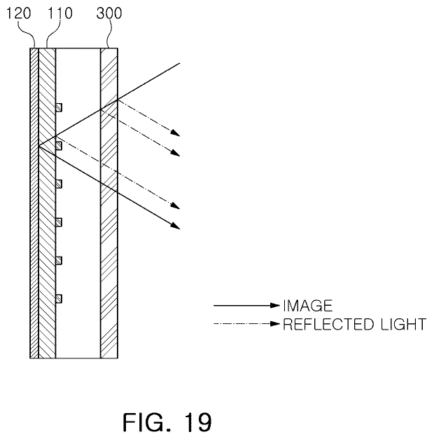

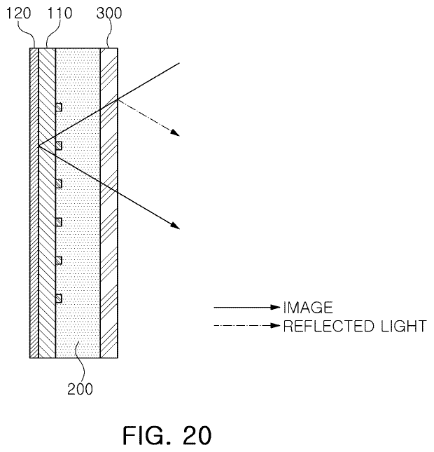

FIGS. 17A and 17B are diagrams illustrating a use state of a lamp assembly 1 according to an example embodiment of the present disclosure. FIGS. 18A and 18B are diagrams illustrating a use state of a lamp assembly 1 according to an example embodiment of the present disclosure. FIG. 19 is a diagram illustrating reflected light of a lamp assembly 1 according to the related art. FIG. 20 is a diagram illustrating reflected light of a lamp assembly 1 according to an example embodiment of the present disclosure.

FIGS. 17A, 17B, 18A, and 18B are example diagrams illustrating the lamp assembly 1 mounted on a vehicle. FIGS. 17A and 18A are example diagrams illustrating the lamp assembly 1 with a light in an OFF state, and FIGS. 17B and 18B are example diagrams illustrating the lamp assembly 1 having a a light in an ON state.

Referring to FIGS. 17A and 17B, in the light emitting sheet portion 100 according to an example embodiment of the present disclosure, the transparent layer 110 and the electrode layer 130 may be provided to be transparent, such that an image layer, on a lower end of the transparent layer 110, may be visually recognized externally.

For example, in the lens portion 300 including the first lens portion 310 provided to be transparent, and the second lens portion 320 provided to have a color, an image below the transparent layer 110 may be recognized externally through the transparent layer 110, the electrode layer 130, and the first lens portion 310.

FIGS. 17A and 17B may provide the lamp assembly 1 in which an image of the image layer 120 has a color different from that of the lens portion 300.

In this case, as illustrated in FIG. 17A, even in a light OFF state, a lower image may be exposed externally and may be recognized externally.

In addition, as illustrated in FIG. 17B, the lamp assembly 1 may be designed to show the image layer together with light of the light emitting structure 131 even in a light OFF state, such that the light ON design and the light OFF design of the lamp assembly 1 may be manufactured in various manners to be visually recognized.

In addition, the lamp assembly 1, including the image layer 120 according to the related art, may be provided in a direction in which light of the light emitting structure 131 is irradiated.

For example, the image layer 120 may be provided in a lamp portion, and light irradiated from the light emitting structure 131 may pass through the image layer 120 of the lamp portion to expose the image.

Here, the image layer 120 may be printed on the lamp portion, or may be implemented by lowering light transmittance of the lens portion 300.

In the lamp assembly 1 according to the related art, when an energy of light irradiated from the light emitting structure 131 is 100, the energy of light passing through the lens portion 300 including the image layer 120 may be (e.g., inevitably) reduced to ⅕ to 1/10. Accordingly, the lamp assembly 1 according to the related art may have significantly low efficiency and an increase in power consumption.

In the lamp assembly 1 according to an example embodiment of the present disclosure, the image layer 120 may be disposed on a rear surface of the light emitting sheet portion 100, and a front surface of the light emitting sheet portion 100 may be irradiated with light through the light emitting structure, thereby transmitting most of the irradiated light energy without loss and lowering power consumption.

FIGS. 18A and 18B may be diagrams illustrating the lamp assembly 1 in which an image of the image layer 120 has a color the same as that of the second lens portion 320.

In this case, as illustrated in FIG. 18A, the overall lamp assembly 1 may be recognized as having a single color.

Referring to FIG. 19, in an assembly of an electrode 132 including an air layer, instead of the clear layer 200, according to the related art, a refractive index of the air layer may be different from that of the lens portion 300 or the transparent sheet portion, causing unnecessary reflected light whenever light passes through the image layer 120 and the second lens portion 320, and the reflected light may distort an original color of the image layer 120.

Accordingly, even when colors of the image layer 120 and the second lens portion 320 are manufactured to be the same, the colors may be recognized externally as different colors from due to reflected light.

Conversely, referring to FIG. 20, the lamp assembly 1 according to an example embodiment of the present disclosure may include the clear layer 200 having a refractive index similar to that of the lens portion 300 or the transparent sheet portion, thereby minimizing reflected light of light passing through the image layer 120 and the second lens portion 320.

Referring back to FIGS. 18A and 18B, the lamp assembly 1 according to an example embodiment of the present disclosure may be (e.g., integrally) recognized externally when the image layer 120 is manufactured have a color the same as that of the lens portion 300.

In addition, even in a light ON state, in the lamp assembly 1 according to an example embodiment of the present disclosure, the light emitting sheet portion 100 including the light emitting structure 131, not recognized in a light OFF state, may be turned on to generate light, thereby exhibiting desirable aesthetics. In addition, an arrangement of the light emitting structure 131 may be adjusted to externally implement various types of images, thereby exhibiting a high degree of design freedom.

While example embodiments have been shown and described above, it will be apparent to those skilled in the art that modifications and variations could be made without departing from the scope of the present disclosure as provided in the claims.

What is claimed is:

1. A method for manufacturing a lamp assembly including a light emitting sheet portion and a lens portion, the method comprising:
mounting the light emitting sheet portion on an upper mold, wherein the light emitting sheet portion generates light;
mounting the lens portion on a lower mold, wherein the lens portion transmits light generated by the light emitting sheet portion;
coupling the upper mold and the lower mold together; and
forming a clear layer having light transmissive properties, the clear layer is provided between the light emitting sheet portion and the lens portion,
wherein the forming the clear layer is performed at room temperature.

2. The method of claim 1, wherein the forming the clear layer includes:
injecting an optical transparent resin; and
curing the optical transparent resin.

3. The method of claim 2, wherein the optical transparent resin is formed of an ultraviolet (UV)-curable resin.

4. The method of claim 2, wherein the optical transparent resin is irradiated with UV rays in the curing the optical transparent resin.

5. The method of claim 1, wherein, in the mounting the light emitting sheet portion on the upper mold, an auxiliary fixing portion, temporarily adhering the light emitting sheet portion and the upper mold to each other, is disposed between the light emitting sheet portion and the upper mold.

6. The method of claim 1, wherein, in the mounting the light emitting sheet portion on the upper mold,
a surface of the light emitting sheet portion is provided in a state in which an image is printed on at least a portion thereof, and
the light emitting sheet portion is mounted on the upper mold such that the surface is in contact with the upper mold.

7. An apparatus for manufacturing a lamp assembly including a light emitting sheet portion and a lens portion, the apparatus comprising:
an upper mold having the light emitting sheet portion mounted thereon, wherein the light emitting sheet portion is configured to generate light;
a lower mold having the lens portion mounted thereon, wherein the lens portion is configured to transmit light generated by the light emitting sheet portion; and
an UV lamp irradiating the upper mold and the lower mold with UV rays, wherein the upper mold and the lower mold allow light to pass therethrough.

8. The apparatus of claim 7, wherein
when the upper mold and the lower mold are pressurized, the light emitting sheet portion and the lens portion come into contact to form a filling space.

9. The apparatus of claim 8, wherein
the upper mold includes an injection port passing through the upper mold, and an optical transparent resin is injected through the injection port into the filling space.

10. The apparatus of claim 9, wherein the injection port is provided to protrude toward a contact surface of the upper mold that is in contact with the light emitting sheet portion.

11. The apparatus of claim 10, wherein the injection port is provided to protrude toward a contact surface of the upper mold that is in contact with the light emitting sheet portion and corresponds to a thickness of the light emitting sheet portion.

12. The apparatus of claim 10, wherein the lens portion has a shape corresponding to a shape of the light emitting sheet portion, and wherein the lens portion includes a rib portion continuously protruding toward the upper mold.

13. The apparatus of claim 12, wherein a portion of the rib portion has a shape corresponding to a shape of the injection port.

14. The apparatus of claim 13, further including an injection auxiliary portion protruding toward the upper mold, wherein the injection auxiliary portion surrounds the injection port.

15. A lamp assembly comprising:
a transparent layer having light transmissive properties;
an electrode layer stacked on the transparent layer, the electrode layer having a light emitting structure configured to generate light;
a lens portion spaced apart from the electrode layer by a predetermined interval, the lens portion provided to surround the electrode layer; and
a clear layer provided between the electrode layer and the lens portion using an optical transparent resin,
wherein a surface on which the electrode layer is stacked is coupled to an image layer.

16. The lamp assembly of claim 15, wherein the lens portion includes:
a first lens portion provided to be transparent.

17. The lamp assembly of claim 16, wherein the lens portion further includes:
a second lens portion connected to the first lens portion, the second lens portion having a first color.

18. The lamp assembly of claim 17, wherein the image layer has a second color, and wherein first color of the second lens portion and the second color of the image layer are the same color.

19. The lamp assembly of claim 15, wherein the optical transparent resin is provided as an optical clear resin (OCR).

20. The lamp assembly of claim 15, wherein the optical transparent resin is provided as an optical clear adhesive (OCA).
